(19) United States
(12) Patent Application Publication
(10) Pub. No.: US 2024/0318425 A1
(43) Pub. Date: Sep. 26, 2024

(54) SUBFLOOR PANEL WITH AN INTEGRATED VAPOR RETARDER

(71) Applicant: Huber Engineered Woods LLC, Charlotte, NC (US)

(72) Inventors: Jason Tolar, Decatur, GA (US); Elden Padgett, Colbert, GA (US); Rebecca Paigh Bumgarner, Pineville, NC (US); Danko Davidovic, Lawrenceville, GA (US); Tim Romans, Jefferson, GA (US)

(21) Appl. No.: 18/125,451

(22) Filed: Mar. 23, 2023

(51) Int. Cl. E04C 2/24; B32B 3/06; B32B 21/02; B32B 21/06; E04B 2/00

(52) U.S. Cl. CPC E04C 2/24; B32B 3/06; B32B 21/02; B32B 21/06; E04C 2/44; B32B 2260/026; B32B 2260/028; B32B 2260/046; B32B 2307/514; B32B 2307/54; B32B 2307/718; B32B 2307/72; B32B 2307/7242; B32B 2307/7376; B32B 2307/744; B32B 2607/00; E04C 2002/004

(57) ABSTRACT

The present disclosure provides for a subfloor panel comprising a lignocellulosic material suitable for use as a subfloor and an integrated vapor retarder coextensive to at least one surface of the lignocellulosic material, wherein the lignocellulosic material comprises a first resin and the vapor retarder comprises a second resin. Further provided herein is a floor assembly comprising one or more subfloor panels as disclosed herein and a flooring material.

### BACKGROUND

Current practices for installing finish flooring over wood-based subfloor use a vapor retarder. Vapor retarders are used to reduce the rate at which water vapor moves through subfloor. They can protect floor assemblies and building from the damage that can be done by condensation. The vapor retarder can be a thin sheet, which can come in the form of rolls, or a coating, which can be applied with a paint roller. Application of a vapor retarder thus requires an additional step when installing most flooring, which increases the flooring installation process time. Further, application of the vapor retarder at the time of flooring installation or building construction can be inconsistent and depend on the skill of the installer. The use of thin sheets of vapor retarder can also limit the options for end use of the wood-based subfloor. More specifically, hardwood can only be nailed to the subfloor when a thin sheet vapor retarder is used, which in turn limits possible finish flooring styles to narrow plank assemblies. Further, roll on coating vapor retarder can create a risk of inducing inconsistent permeance due to variation in the thickness of the vapor retarder during the install process.

Therefore, there is a need for those that install flooring to be able to install flooring directly onto a subfloor, without the added step of putting down a vapor retarder. Likewise, it is desirable to have other building materials where a vapor retarder is already present on the material, thus avoiding additional steps of adding a vapor retarder later at the time of construction. The products and assemblies disclosed herein address these and other needs.

### SUMMARY

In accordance with the purposes of the disclosed materials and methods, as embodied and broadly described herein, the disclosed subject matter, in one aspect, relates to a subfloor panel and a floor assembly comprising thereof.

Thus, in one example, a subfloor panel is provided, including a lignocellulosic material suitable for use as a subfloor and an integrated vapor retarder coextensive to at least one surface of the lignocellulosic material, wherein the lignocellulosic material comprises a first resin and the vapor retarder comprises a second resin.

In a further example, a floor assembly is provided, including one or more subfloor panels as disclosed herein and a flooring material.

Additional advantages will be set forth in part in the description that follows, and in part will be obvious from the description, or may be learned by practice of the examples described below. The advantages described below will be realized and attained by means of the elements and combinations particularly pointed out in the appended claims. It is to be understood that both the foregoing summary and the following detailed description are exemplary and explanatory only and are not restrictive.

### BRIEF DESCRIPTION OF THE DRAWINGS

The accompanying figures, which are incorporated in and constitute a part of this specification, illustrate several aspects of the disclosure, and together with the description, explain the principles of the disclosure.

FIG. 1 contains graphs of the mass over time of an example cured vapor retarder with a screen imprint after water vapor transmission and permeance testing using the desiccant method. The graphs show the change in mass over time for Specimens 1, 2, and 3, as described in Example 1.

FIG. 2 contains graphs of the mass over time of an example cured vapor retarder overlay without a screen after water vapor transmission and permeance testing using the desiccant method. The graphs show the change in mass over time for Specimens 1, 2, and 3, described in Example 1.

FIG. 3 contains graphs of the mass over time of a subfloor panel after water vapor transmission and permeance testing using the water method. The graphs show the change in mass over time for Specimens 1, 2, and 3, described in Example 2.

FIG. 4 contains graphs of the mass over time of two subfloor panels joined at the tongue and groove joints, without adhesive applied at the seam, after water vapor transmission and permeance testing using the water method. The graphs show the change in mass over time for Specimens 1, 2, and 3, described in Example 2.

FIG. 5 contains graphs of the mass over time of two subfloor panels joined at the tongue and groove joints, with adhesive applied at the seam, after water vapor transmission testing using the water method. The graphs show the change in mass over time for Specimens 1, 2, and 3, described in Example 2.

FIG. 6 is a schematic drawing of a subfloor panel that comprises a lignocellulosic panel and a vapor retarder integrated therewith.

FIG. 7 is a picture of an example subfloor panel wherein the surface comprising the vapor retarder includes product branding and the fastening guide.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, includes, but is not limited to, one or more such compounds. Reference to “an adhesive” includes, but is not limited to, more than one such adhesive, and the like.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise. As used herein, the term “substantially free,” when used in the context of a composition or component of a composition that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the composition.

It should be noted that ratios, concentrations, amounts, and other numerical data can be expressed herein in a range format. It can be further understood that the endpoints of each of the ranges are significant both in relation to the other endpoint, and independently of the other endpoint.

All parts, percentages, and ratios used herein are expressed by weight unless otherwise specified.

### Composition

Disclosed herein are subfloor panels comprising a lignocellulosic material and an integrated vapor retarder coextensive to at least one surface of the lignocellulosic material. The lignocellulosic material can be suitable for use as a subfloor. The panels slow the transmission of water vapor from a higher humidity environment, including below the subfloor. More specifically, the disclosed subfloor panel slows the transmission of water vapor such that the water vapor does not cause excess movement or discoloration of the finished flooring above the subfloor assembly. The vapor retarder can be on the top surface of the subfloor, bottom surface of the subfloor, or both.

The subfloor panel can be produced, for example, by feeding the vapor retarder onto a forming line either on top of or below a lignocellulosic material. Heat and pressure can then be applied to bond the lignocellulosic material and vapor retarder to create the subfloor panel. The pressure can also impart a skid resistant surface on the vapor retarder when pressure is applied when the vapor retarder is in contact with a conveyer screen and resin has been impregnated into the vapor retarder. This may be known as a primary process. The subfloor panel can then be cut into predetermined sizes.

In some other examples, the subfloor panel can be formed via applying heat and pressure to the lignocellulosic material and then the vapor retarder is integrated to the lignocellulosic material subsequent to application of heat and pressure of the lignocellulosic material. This can be accomplished by, for example, applying an additional adhesive to bond the vapor retarder and already processed lignocellulosic material. The adhesive can be applied to the vapor retarder, processed lignocellulosic material, or both. In some examples, no additional heat and/or pressure is used with the additional adhesive in order to integrate the vapor retarder to the already processed lignocellulosic material. In other examples, heat and/or pressure are used with the additional adhesive to integrate the vapor retarder to the already processed lignocellulosic material. This process may be known as a secondary process.

### Subfloor Panel

Provided herein is a subfloor panel comprising a lignocellulosic material suitable for use as a subfloor and an integrated vapor retarder coextensive to at least one surface of the lignocellulosic material, wherein the lignocellulosic material comprises a first resin and the vapor retarder comprises a second resin. In some examples, the vapor retarder is on a top and bottom surface of the lignocellulosic material.

In some examples, the vapor retarder is integrated to a top surface of the lignocellulosic material, a bottom surface of the lignocellulosic material, or both the top and bottom surfaces of the lignocellulosic material. In further examples, the top surface of the lignocellulosic material or the bottom surface of the lignocellulosic material is sanded. In the examples wherein the vapor retarder is on only one surface of the lignocellulosic material, the surface opposite the vapor retarder can be sanded or unsanded.

Subfloor serves as the structural foundation beneath finish flooring. Subfloor is fixed to an underlying framing, which can include joists or on-center (OC) framing. In certain examples, the subfloor panel can comprise wood planks, plywood, oriented strand board (OSB), particleboard, or any combination thereof. In further examples, the plywood, wood planks, OSB, and particleboard comprise lignocellulosic material.

Lignocellulosic material refers to a material comprising any lignocellulosic biomass, such as wood, bamboo, straw, plant waste, or combinations thereof. In specific examples disclosed herein, the lignocellulosic material comprises wood and can include, for example, oriented strand board (OSB), waferboard, particleboards, chipboard, medium density fiberboard (MDF), plywood, or boards that are a composite of strands and ply veneers. Lignocellulosic material is a structural member, such as a panel, that is suitable for use with finished flooring, e.g., a support member for hardwood floors, carpeted floors, tiled floors, linoleum floors, and the like.

In some examples, the wood in lignocellulosic material can include a hardwood, a softwood, wood composite, or any combination thereof. Wood includes cellular structure having cell walls comprising cellulose and hemicellulose fibers bonded together by lignin polymer. Wood can include natural woods such as pine, redwood, cedar, cypress, Douglas fir, mahogany, such as African mahogany, ipe, oak, maple, cherry, walnut, ash, or any combination thereof.

In some examples, the lignocellulosic material comprises OSB. In further examples, the OSB comprises a first resin. The resin can be mixed in with the wood in the OSB and in certain examples, at least a portion of the resin is uncured. In specific examples, the resin is heat activated and upon application of heat and pressure over a period of time, the resin cures, thereby contributing to the integration of the vapor retarder to the lignocellulosic material.

In some examples, the resin comprises a methanol, phenol, or any combination thereof. In further examples, the resin comprises a thermosetting polymer. In some examples, the resin comprises formaldehyde. In certain examples, the resin can include phenol formaldehyde (PF), melamine formaldehyde, or any combination thereof. In specific examples, the resin comprises phenyl formaldehyde. In further examples, the first resin comprises phenyl formaldehyde (PF).

In further examples, the resin comprises isocyanate. In further examples, the first resin comprises isocyanate. In some examples, the isocyanate comprises polymeric methylene diphenyl diisocyanate (pMDI). In some examples, the isocyanate comprises methylenebis(phenyl isocyanate) (MDI), polymeric methylene diphenyl diisocyanate (pMDI), ethylenebis(phenyl isocyanate) (EDI), toluene diisocyanate (TDI), hexamethylene diisocyanate (HDI), naphthalene diisocyanate (NDI), methylene bis-cyclohexylisocyanate (HMDI; hydrogenated MDI, isophorone diisocyanate (IPDI), or any combination thereof.

MDI further includes polymeric MDI (pMDI), which is a mixture that can include from 25% to 80% monomeric 4,4′-MDI as well as oligomers containing 3-6 rings and other minor isomers, such as the 2,2′ isomer. The exact composition of pMDI varies with the manufacturer. pMDI can also be referred to as polymeric diphenylmethane diisocyanate or polymethylene polyphenylisocyanates. The chemical structure of an example pMDI is shown in Formula I.

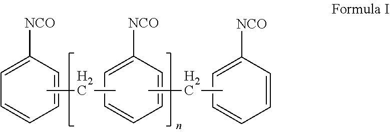

Various types of lignocellulosic materials are conventional and known in the art and can be purchased from various suppliers.

The subfloor panel further comprises an integrated vapor retarder coextensive to at least one surface of the lignocellulosic material. A vapor retarder is a material that resists water vapor diffusion through the ceiling, wall, and floor of a building. The vapor retarder can comprise any material that provides this vapor retarding functionality.

In some examples, the vapor retarder comprises paper. The vapor retarder can include high or medium density overlay materials, such as crepe paper or kraft paper, for example. In further examples, the vapor retarder can include a foil overlay. In some examples, the vapor retarder further comprises a primer, wherein the primer is applied to one side of the vapor retarder. In certain examples, the primer is cured.

In some examples, the vapor retarder further comprises an ultraviolet (UV) stabilizer. In further examples, the primer comprises the UV stabilizer.

A UV stabilizer is included in the vapor retarder to provide fade resistance and help prevent fading of any color of the vapor retarder, wherein fading of the color corresponds to a decrease in performance of the vapor retarder.

UV stabilizers can include UV screeners, UV absorbers, UV quenchers, or hindered amine light stabilizers (HALS). UV screeners are pigments and, in some examples, can include carbon black, titanium dioxide, zinc oxide, or any combination thereof. In some examples, UV absorbers can include benzophenones, benzotriazoles, aryl esters, oxanilides, acrylic esters, formamidine, or any combination thereof. In some examples, UV quenchers can include organic nickel compounds, such as nickel salts. HALS are derivatives of 2,2,6,6-tetramethyl piperidine.

In specific examples, the vapor retarder further comprises a resin. In some examples, the vapor retarder comprises glue. In some examples, the glue is in the form of a glue line, wherein the glue line comprises the resin. In other examples, the resin is partially cured. The resin can be heat activated such that when it undergoes application of heat and pressure for a period of time, it reacts with cellulose and/or the cured resin in the OSB, thereby forming a surface chemical bond with the OSB. Various resins are conventional and known in the art and applied in an amount that maintains the functionality of the vapor retarder and can be purchased from various suppliers.

In some examples, the first resin and the second resin comprise different resins.

The vapor retarder can be manufactured by saturating the material of choice, such as kraft or crepe paper, with the resin and then curing the resin.

In some examples, the vapor retarder comprises a screen imprint. A screen imprint is an impression on the vapor retarder that results from the screen used as a part of the pressing operation used to manufacture the subfloor panel. In further examples, the vapor retarder surface of the subfloor panel that comprises a screen imprint includes product branding and a fastening guide.

In some examples, the vapor retarder can have a paper basis weight of from 50 to 150 lbs. per 100 square feet. In further examples, the vapor retarder can have a paper basis weight of from about 50 to about 100, or about 100 to about 150 lbs. per 100 sq. ft. In certain examples, the vapor retarder can have a paper basis weight of from about 50 to about 75, about 75 to about 100, about 100 to about 125, or about 125 to about 150 lbs. per 100 sq. ft. In specific examples, the vapor retarder can have a paper basis weight of from about 80 to about 90, or about 90 to about 100 lbs. per 100 sq. ft. In some examples, the vapor retarder can have a paper basis weight of from about 85 to about 95 lbs. per 100 sq. ft. In further examples, the vapor retarder can have a paper basis weight of from about 85 to about 87, about 87 to about 89, about 89 to about 91, about 91 to about 93, or about 93 to about 95 lbs. per 100 sq. ft. In certain examples, the vapor retarder can have a paper basis weight of from about 85 to about 89, about 85 to about 91, or about 85 to about 93 lbs. per 100 sq. ft. In specific examples, the vapor retarder can have a paper basis weight of about 90 lbs. per 100 sq. ft. The vapor retarder weight as provided herein is paper basis weight and relates to a vapor retarder saturated with resin as disclosed herein.

In some examples, the vapor retarder is integrated onto at least one surface of the lignocellulosic material via a chemical reaction, such that the vapor retarder maintains its vapor retardance properties. The vapor retarder is not merely attached to the lignocellulosic material via mechanical means such as nails or staples, or via adhesive.

The chemical reaction that integrates the vapor retarder onto at least one surface of the lignocellulosic material comprises applying the vapor retarder to the lignocellulosic material and subjecting the vapor retarder and lignocellulosic material to heat and pressure on a press for a duration of time.

In some examples, the lignocellulosic material and the vapor retarder can be integrated via a pressing operation during manufacture, wherein the vapor retarder is rolled out over the lignocellulosic material and the bond is activated by heat and pressure applied in a press over time during manufacturing. In further examples, the press can operate via either a continuous motion pressing or a multi-opening pressing operation. In specific examples, the lignocellulosic material and the vapor retarder can be integrated to form a subfloor panel such that the vapor retarder is on at least one surface of the lignocellulosic material. In certain examples, the vapor retarder covers the entirety of the at least one surface. In some examples, the at least one surface comprising the vapor retarder includes product branding and the fastening guide.

In some examples, the heat applied is from about 385 to about 550° F. In further examples, the heat applied is from about 385 to about 400° F., about 400 to about 415° F., about 415 to about 430° F., about 430 to about 445° F., about 445 to about 460° F., about 460 to about 475° F., about 475 to about 490° F., about 490 to about 505° F., about 505 to about 520° F., about 520 to about 535° F., or about 535 to about 550° F. In certain examples, the heat applied is from about 385 to about 415° F., about 385 to about 430° F., about 385 to about 445° F., about 385 to about 460° F., about 385 to about 475° F., about 385 to about 490° F., about 385 to about 505° F., about 385 to about 520° F., or about 385 to about 535° F. In specific examples, the heat applied is from about 415 to about 445° F., about 445 to about 475° F., about 475 to about 505° F., or about 505 to about 535° F. In some examples, the heat is applied from about 400 to about 425° F. In further examples, the heat is applied from about 400 to about 405° F., about 405 to about 410° F., about 410 to about 415° F., about 415 to about 420° F., or about 420 to about 425° F. In certain examples, the heat is applied from about 400 to about 410° F., about 400 to about 415° F., about 400 to about 420° F., or about 400 to about 425° F. In specific examples, the heat is applied from about 400 to about 402° F., about 402 to about 404° F., about 404 to about 406° F., about 406 to about 408° F., about 408 to about 410° F., about 410 to about 412° F., about 412 to about 414° F., about 414 to about 416° F., about 416 to about 418° F., about 418 to about 420° F., about 420 to about 422° F., about 422 to about 424° F., or about 424° F. to about 426° F. In some examples, the heat is applied from about 400 to about 404° F., about 400 to about 406° F., about 400 to about 408° F., about 400 to about 410° F., about 400 to about 412° F., about 400 to about 414° F., about 400 to about 416° F., about 400 to about 418° F., about 400 to about 420° F., about 400 to about 422° F., about 400 to about 424° F., or about 400° F. to about 426° F.

In some examples, the pressure applied is from about 500 to about 1000 psi. In other examples, the pressure applied is from about 500 to about 550 psi, about 550 to about 600 psi, about 600 to about 650 psi, about 650 to about 700 psi, about 700 to about 750 psi, about 750 to about 800 psi, about 800 to about 850 psi, about 850 to about 900 psi, about 900 to about 950 psi, or about 950 to about 1000 psi. In some examples, the pressure is applied from about 500 to about 600 psi, about 500 to about 650 psi, about 500 to about 700 psi, about 500 to about 750 psi, about 500 to about 800 psi, about 500 to about 850 psi, about 500 to about 900 psi, or about 500 to about 950 psi. In certain examples, the pressure applied is from about 500 to about 600 psi, about 600 to about 700 psi, about 700 to about 800 psi, about 800 to about 900 psi, or about 900 to about 1000 psi. In some examples, the pressure applied is from about 500 to about 700 psi, about 500 to about 800 psi, or about 500 to about 900 psi. In further examples, the pressure applied is from about 500 to about 525 psi, about 525 to about 550 psi, about 550 to about 575 psi, about 575 to about 600 psi, about 600 to about 625 psi, about 625 to about 650 psi, about 650 to about 675 psi, about 675 to about 700 psi, about 700 to about 725 psi, about 725 to about 750 psi, about 750 to about 775 psi, about 775 to about 800 psi, about 800 to about 825 psi, about 825 to about 850 psi, about 850 to about 875 psi, about 875 to about 900 psi, about 900 to about 925 psi, about 925 to about 950 psi, about 950 to about 975 psi, or about 975 to about 1000 psi. In certain examples, the pressure applied is from about 500 to about 550 psi, about 500 to about 575 psi, about 500 to about 600 psi, about 500 to about 625 psi, about 500 to about 650 psi, about 500 to about 675 psi, about 500 to about 700 psi, about 500 to about 725 psi, about 500 to about 750 psi, about 500 to about 775 psi, about 500 to about 800 psi, about 500 to about 825 psi, about 500 to about 850 psi, about 500 to about 875 psi, about 500 to about 900 psi, about 500 to about 925 psi, about 500 to about 950 psi, or about 500 to about 975 psi.

In specific examples, the pressure applied is from about 500 to about 510 psi, about 510 to about 520 psi, about 520 to about 530 psi, about 530 to about 540 psi, about 540 to about 550 psi, about 550 to about 560 psi, about 560 to about 570 psi, about 570 to about 580 psi, about 580 to about 590 psi, about 590 to about 600 psi, about 600 to about 610 psi, about 610 to about 620 psi, about 620 to about 630 psi, about 630 to about 640 psi, about 640 to about 650 psi, about 650 to about 660 psi, about 660 to about 670 psi, about 670 to about 680 psi, about 680 to about 690 psi, about 690 to about 700 psi, about 700 psi to about 710 psi, about 710 to about 720 psi, about 720 to about 730 psi, about 730 to about 740 psi, about 740 to about 750 psi, about 750 to about 760 psi, about 760 to about 770 psi, about 770 to about 780 psi, about 780 to about 790 psi, about 790 to about 800 psi, about 800 psi to about 810 psi, about 810 to about 820 psi, about 820 to about 830 psi, about 830 to about 840 psi, about 840 to about 850 psi, about 850 to about 860 psi, about 860 to about 870 psi, about 870 to about 880 psi, about 880 to about 890 psi, about 890 to about 900 psi, about 910 to about 920 psi, about 920 to about 930 psi, about 930 to about 940 psi, about 940 to about 950 psi, about 950 to about 960 psi, about 960 to about 970 psi, about 970 to about 980 psi, about 980 to about 990 psi, or about 990 to about 1000 psi. In specific examples, the pressure applied is from about 500 to about 520 psi, about 500 to about 530 psi, about 500 to about 540 psi, about 500 to about 550 psi, about 500 to about 560 psi, about 500 to about 570 psi, about 500 to about 580 psi, about 500 to about 590 psi, about 500 to about 600 psi, about 500 to about 610 psi, about 500 to about 620 psi, about 500 to about 630 psi, about 500 to about 640 psi, about 500 to about 650 psi, about 500 to about 660 psi, about 500 to about 670 psi, about 500 to about 680 psi, about 500 to about 690 psi, about 500 to about 700 psi, about 500 to about 720 psi, 500 to about 730 psi, about 500 to about 740 psi, about 500 to about 750 psi, about 500 to about 760 psi, about 500 to about 770 psi, about 500 to about 780 psi, about 500 to about 790 psi, about 500 to about 800 psi, about 500 to about 820 psi, about 500 to about 830 psi, about 500 to about 840 psi, about 500 to about 850 psi, about 500 to about 860 psi, about 500 to about 870 psi, about 500 to about 880 psi, about 500 to about 890 psi, about 500 to about 900 psi, about 500 to about 920 psi, about 500 to about 930 psi, about 500 to about 940 psi, about 500 to about 950 psi, about 500 to about 960 psi, about 500 to about 970 psi, about 500 to about 980 psi, or about 500 to about 990 psi.

In some examples, the heat and pressure are applied from about 2 to about 5 minutes. In further examples, the heat and pressure are applied from about 2 to about 3 minutes, about 3 to about 4 minutes, or about 4 to about 5 minutes. In certain examples, the heat and pressure are applied from about 2 to about 4 minutes. In specific examples, the heat and pressure are applied from about 2 minutes to about 2 minutes and 30 second, about 2 minutes and 30 seconds to about 3 minutes, about 3 minutes to about 3 minutes and 30 seconds, about 3 minutes and 30 seconds to about 4 minutes, about 4 minutes to about 4 minutes and 30 seconds, or about 4 minutes and 30 seconds to about 5 minutes. In some examples, the heat and pressure are applied from about 2 minutes to about 3 minutes, about 2 minutes to about 3 minutes and 30 seconds, about 2 minutes to about 4 minutes, or about 2 minutes to about 4 minutes and 30 seconds. In further examples, the heat and pressure are applied from about 2 minutes to about 2 minutes and 15 seconds, about 2 minutes and 15 seconds to about 2 minutes and 30 seconds, about 2 minutes and 30 seconds to about 2 minutes and 45 seconds, about 2 minutes and 45 seconds to about 3 minutes, about 3 minutes to about 3 minutes and 15 seconds, about 3 minutes and 15 seconds to about 3 minutes and 30 seconds, about 3 minutes and 30 seconds to about 3 minutes and 45 seconds, about 3 minutes and 45 seconds to about 4 minutes, about 4 minutes to about 4 minutes and 15 seconds, about 4 minutes and 15 seconds to about 4 minutes and 30 seconds, about 4 minutes and 30 seconds to about 4 minutes and 45 seconds, or about 4 minutes and 45 seconds to about 5 minutes. In certain examples, the heat and pressure are applied from about 2 minutes and 15 seconds to about 2 minutes and 30 seconds, about 2 minutes to about 2 minutes and 45 seconds, about 2 minutes to about 3 minutes, about 2 minutes to about 3 minutes and 15 seconds, about 2 minutes to about 3 minutes and 30 seconds, about 2 minutes to about 3 minutes and 45 seconds, about 2 minutes to about 4 minutes, about 2 minutes to about 4 minutes and 15 seconds, about 2 minutes to about 4 minutes and 30 seconds, or about 2 minutes to about 4 minutes and 45 seconds.

In some examples, the heat, pressure, and duration of time are dependent on the thickness of the lignocellulosic material. When heat and pressure are applied, the resin in the vapor retarder is reactivated and reacts with the cellulose and/or the resin in the lignocellulosic material, thereby forming a surface chemical bond between the vapor retarder and lignocellulosic material and fully integrating the vapor retarder to the lignocellulosic material to form the subfloor panel.

Vapor retarders can be classified as Class I, Class II, or Class III vapor retarders, wherein Class I vapor retarders, also known as vapor barriers, are considered impermeable and have a permeance of 0.1 perms or less. Class III vapor retarders are considered semi-impermeable and have a permeance of from 1.0 to 10 perms. Class II vapor retarders are considered semi-impermeable and have a permeance of from 0.1 to 1.0 perms. A Class II vapor retarder can be used on wood subfloors over unconditioned spaces to slow the rate at which potential moisture-laden air moved through the assembly and into the wood flooring, unless otherwise directed by the flooring manufacturer. The subfloor panel described herein is a Class II vapor retarder.

In some examples, the subfloor panel has a permeance of from about 0.1 to about 1.0 perms, as per ASTM E96 (2022) water method (Method B). In further examples, the subfloor panel has a permeance of from about 0.1 to about 1.0 perms, as measured per ASTM E96-22 desiccant method (Method A). In certain examples, the subfloor panel has a permeance of from about 0.1 to about 1.0 perms, as measured per ASTM E96-22 desiccant method (Method A) and/or ASTM E96-22 water method (Method B). ASTM E96 (2022) desiccant method (Method A) tests the permeance of the vapor retarder, while ASTM E96 (2022) water method (Method B) tests the permanence of the subfloor panel comprising the integrated vapor retarder and subfloor.

In some examples, the subfloor panel can have a permeance per ASTM E96 (2022) water method (Method B) of from about 0.1 to about 0.2, about 0.1 to about 0.3, about 0.1 to about 0.4, about 0.1 to about 0.5, about 0.1 to about 0.6, about 0.1 to about 0.7, about 0.1 to about 0.8, or about 0.1 to about 0.9 perms. In further examples, the vapor retarder can have a permeance of from about 0.1 to about 0.2, about 0.2 to about 0.4, about 0.4 to about 0.6, about 0.6 to about 0.8, or about 0.8 to about 1.0 perms. In certain examples, the vapor retarder can have a permeance of from about 0.1 to about 0.2, about 0.2 to about 0.3, about 0.3 to about 0.4, about 0.4 to about 0.5, about 0.5 to about 0.6, about 0.6 to about 0.7, about 0.7 to about 0.8, about 0.8 to about 0.9, to about 0.9 to about 1.0 perms.

In some examples, the subfloor panel can have a density of from about 38 to about 50 pounds per feet cubed (lbs./ft.³). In further examples, the subfloor panel can have a density of from about 38 to about 40 lbs./ft.³, about 40 to about 42 lbs./ft.³, about 42 to about 44 lbs./ft.³, about 44 to about 46 lbs./ft.³, about 46 to about 48 lbs./ft.³, or about 48 to about 50 lbs./ft.³. In certain examples, the subfloor panel can have a density of from about 38 to about 42 lbs./ft.³, about 38 to about 44 lbs./ft.³, about 38 to about 46 lbs./ft.³, or about 38 to about 48 lbs./ft.³. In specific examples, the subfloor panel can have a density of from about 38 to about 44 lbs./ft.³, or about 44 to about 50 lbs./ft.³.

In some examples, the subfloor panel can have a modulus of elasticity of from about 0.4×10⁶ to about 1.2×10⁶ pounds per square inch (psi). In further examples, the subfloor panel can have a modulus of elasticity of from about 0.4×10⁶ to about 0.6×10⁶ psi, about 0.6×10⁶ to about 0.8×10⁶ psi, about 0.8×10⁶ to about 1.0×10⁶ psi, or about 1.0×10⁶ to about 1.2×10⁶ psi. In certain examples, the subfloor panel can have a modulus of elasticity of from about 0.4×10⁶ to about 0.8×10⁶ psi, about 0.4×10⁶ to about 1.0×10⁶ psi, or about 0.4×10⁶ to about 1.2×10⁶ psi. In specific examples, the subfloor panel can have a modulus of elasticity of from about 0.8×10⁶ to about 1.2×10⁶ psi.

In some examples, the subfloor panel can have a wet coefficient of friction of from about 0.6 to about 1.3. In further examples, the subfloor panel can have a wet coefficient of friction of from about 0.6 to about 0.7, about 0.7 to about 0.8, about 0.8 to about 0.9, about 0.9 to about 1.0, about 1.0 to about 1.1, about 1.1 to about 1.2, or about 1.2 to about 1.3. In certain examples, the subfloor panel can have a wet coefficient of friction of from about 0.6 to about 0.8, about 0.6 to about 0.9, about 0.6 to about 1.0, about 0.6 to about 1.1, or about 0.6 to about 1.2. The wet coefficient of friction is measured as outlined in the ASTM D1894 (2014) sled test standard.

In further examples, the subfloor panel can have a dry coefficient of friction of about 0.9 or higher. In some examples, the subfloor panel can have a dry coefficient of from about 0.9 to about 1.0. In further examples, the subfloor panel can have a dry coefficient of from about 0.90 to about 0.92, about 0.92 to about 0.94, about 0.94 to about 0.96, about 0.96 to about 0.98, or about 0.98 to 1.0. In certain examples, the subfloor panel can have a dry coefficient of from about 0.90 to about 0.94, about 0.90 to about 0.96, or about 0.90 to about 0.98. The dry coefficient of friction is measured as outlined in the ASTM D1894 (2014) sled test standard.

In some examples, the subfloor panel can have a thickness of from about 0.650 to about 1.175 inches. In further examples, the subfloor panel can have a thickness of from about 0.650 to about 0.800 or about 0.800 to about 1.175 inches. In certain examples, the subfloor panel can have a thickness of from about 0.800 to about 0.850, about 0.850 to about 0.900, about 0.900 to about 0.950, about 0.950 to about 1.000, or about 1.000 to about 1.175 inches.

In some examples, the subfloor panel can have a thickness of from 0.650 to 0.800 inches. In further examples, the subfloor panel can have a thickness of from 0.650 to 0.700 inches, about 0.700 to about 0.750 inches, or about 0.750 to about 0.800 inches. In certain examples, the subfloor panel can have a thickness of from about 0.650 to about 0.675 inches, about 0.675 to about 0.700 inches, about 0.700 to about 0.725 inches, about 0.725 to about 0.750 inches, about 0.750 to about 0.775 inches, or about 0.775 to about 0.800 inches. In specific examples, the subfloor panel can have a thickness of from about 0.650 to about 0.725 inches, about 0.650 to about 0.750 inches, or about 0.650 to about 0.775 inches.

In some examples, the subfloor panel can have a thickness of from about 0.700 to about 0.710 inches, about 0.710 to about 0.720 inches, about 0.720 to about 0.730 inches, about 0.730 to about 0.740 inches, or about 0.740 to about 0.750 inches. In further examples, the subfloor panel can have a thickness of from about 0.700 to about 0.720 inches, about 0.700 to about 0.730 inches, or about 0.700 to about 0.740 inches. In certain examples, the subfloor panel can have a thickness of from about 0.710 to about 0.712 inches, about 0.712 to about 0.714 inches, about 0.714 to about 0.716 inches, about 0.716 to about 0.718 inches, or about 0.718 to about 0.720 inches. In specific examples, the subfloor panel can have a thickness of from about 0.710 to about 0.714 inches, about 0.710 to about 0.716 inches, or about 0.710 to about 0.718 inches. In further examples, the subfloor panel thickness can be about 0.715 inches.

In some examples, the subfloor panel comprises the vapor retarder which comprises paper and a first resin, further wherein the lignocellulosic material comprises oriented strand board which oriented strand board further comprises a second resin, wherein the second resin comprises pMDI, further wherein the subfloor panel has a permeance level of from about 0.1 to about 1.0 perms, as measured per ASTM E96-22 water method (Method B).

In further examples, the subfloor panel comprises the vapor retarder which comprises paper and a first resin, further wherein the lignocellulosic material comprises oriented strand board which oriented strand board further comprises a second resin, wherein the second resin comprises pMDI, further wherein the subfloor panel has a permeance level of from about 0.1 to about 1.0 perms, as measured per ASTM E96-22 desiccant method (Method A).

In certain examples, the subfloor panel comprises the vapor retarder which comprises paper and a first resin, further wherein the lignocellulosic material comprises oriented strand board which oriented strand board further comprises a second resin, wherein the second resin comprises pMDI, further wherein the subfloor panel has a permeance level of from about 0.1 to about 1.0 perms, as measured per ASTM E96-22 desiccant method (Method A) and/or ASTM E96-22 water method (Method B).

### Floor Assembly

Also provided herein is a floor assembly comprising one or more subfloor panels as disclosed herein and a flooring material. In some examples, the vapor retarder is between the lignocellulosic material and the flooring material.

In some examples, the flooring material comprises a hardwood flooring material, engineered flooring material, natural stone tile, porcelain tile, or linoleum.

In some examples, multiple subfloor panels are present and joined together with a tongue and groove joint.

In some examples, multiple subfloor panels are present and are sealed together at the edges (in or over the joints or seams between subfloor panels which are adjacent to each other) with a seam sealant such as an adhesive, or tape, thereby forming seams between subfloor panels.

In some examples, multiple subfloor panels are present and are sealed between with seam sealant, e.g., tape.

In some examples, the floor assembly comprises seam sealant. Seam sealant is used to seal the seams between the subfloor assembly panels. In some examples, seam sealant can comprise caulk, foam, spray, putty, or other mechanical means. Various seam sealants are conventional and known in the art and can be purchased from various suppliers. In a further example, a plurality of strips of tape are used to seal seams between adjacent panels. In some examples, the tape can be permeable. Any method of sealing together subfloor panels can be used herein as long as the method of sealing does not impact the vapor retarding function of the subfloor panel.

In some examples, the floor assembly further comprises at least one subfloor fastener positioned to fasten the floor assembly to an underlying framing.

Example methods of fastening the subfloor assembly to the underlying framing include use of a pneumatic nail gun, collated screw gun, framing hammer, or any combination thereof. Any subfloor fastener, such as a nail, screw, or hybrid fastener, can be used to attach the subfloor to framing and in some examples, can be used with the provided methods of fastening. In examples wherein the subfloor thickness is less than or equal to 23/32 inches, an 8d nail or #8 screw can be used. In examples wherein the subfloor thickness is greater than 23/32 inches, a 10d nail or #9 screw can be used. In further examples, the fastener of choice can include a ring-shank nail, threaded shank nail, subfloor/deck screw, or any combination thereof. In further examples, the fastener of choice must achieve at least 1-inch of penetration into the frame.

Further, any of these disclosed fastening methods can be coupled with the use of subfloor adhesive, which can be applied via a subfloor adhesive gun on the floor framing and/or portions of the subfloor panels which will contact the floor framing.

In some examples, subfloor adhesive is designed to bond subflooring panels to floor framing. In further examples, subfloor adhesive can be solvent-based or water-based. In certain examples, subfloor adhesive can comprise polyurethane, isocyanate, or any combination thereof.

The methods of fastening the subfloor assembly to underlying framing can be used in conjunction with a fastening guide.

A fastening guide provides demarcation on the subfloor corresponding to certain widths of on-center (OC) framing, a type of underlying framing, wherein the OC framing is attached to the subfloor assembly. In some embodiments, subfloor is marked with shapes (e.g., circle, diamond, or square) and each shape corresponds to a different width of OC framing (e.g., 16 inch, 19.2 inch, or 24 inch width).

In some examples, the floor assembly further comprises finished flooring. Finished flooring includes the flooring material and the additional components used to install the flooring material into serviceability on top of the subfloor panel.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Water Vapor Transmission and Permeance of Vapor Retarder Material Only-Desiccant Method

Product 1: Cured Vapor Retarder with Screen Imprint

The test vapor retarder specimens were cured vapor retarder prior to integration with lignocellulosic material. The vapor retarder comprised resin and paper with a screen imprint. The vapor retarder was cured by pressing the paper in a mini press using heat, time, and pressure. Herein, a small-scale conveyor screen, which can be used when integrating the vapor retarder and lignocellulosic material, was used to apply the imprint.

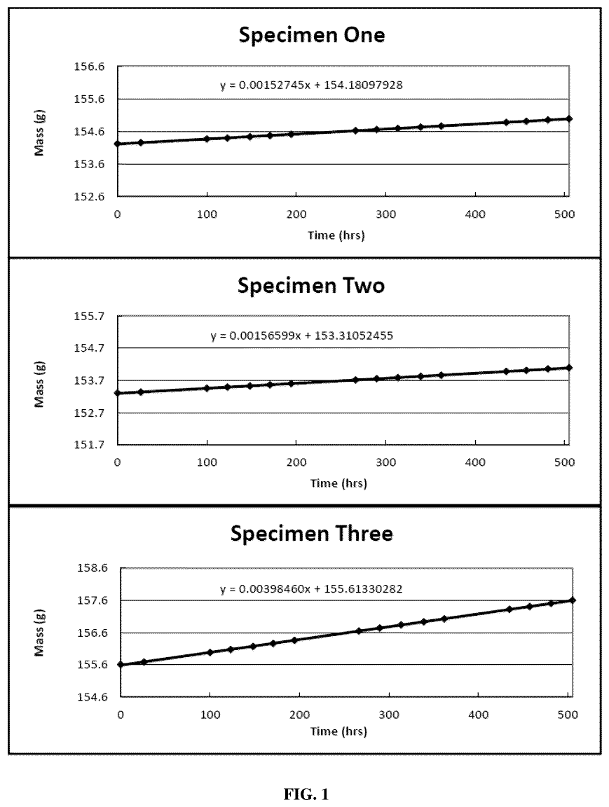

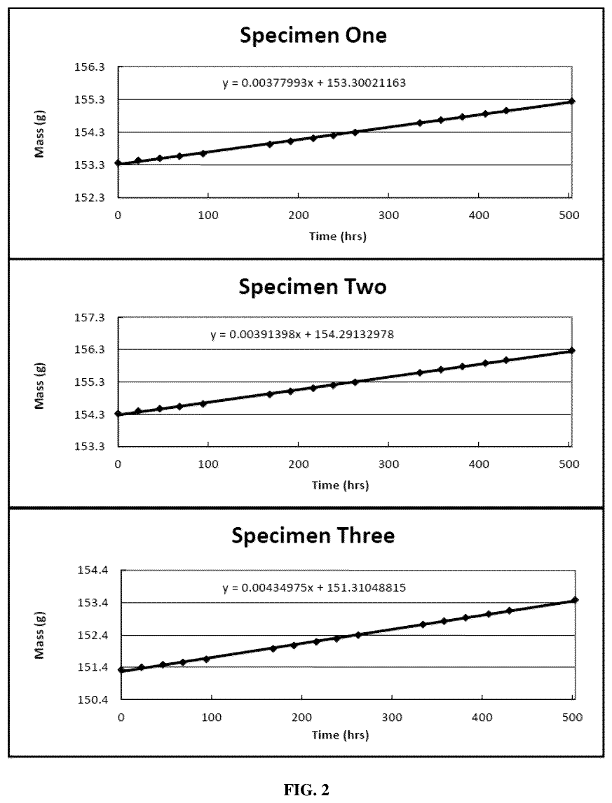

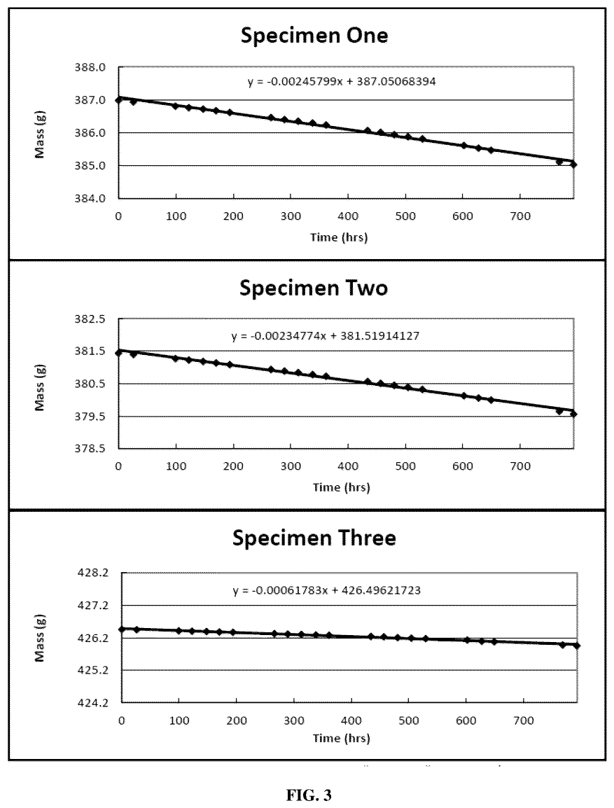

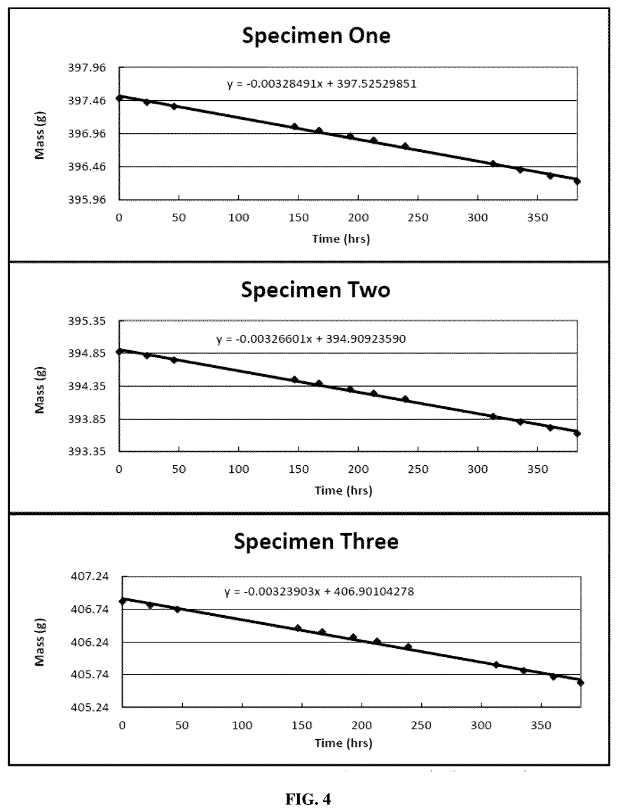

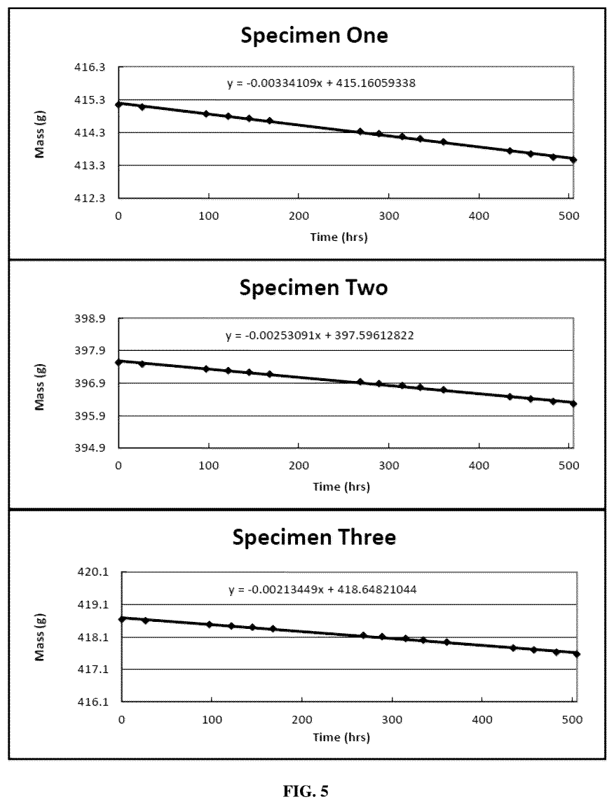

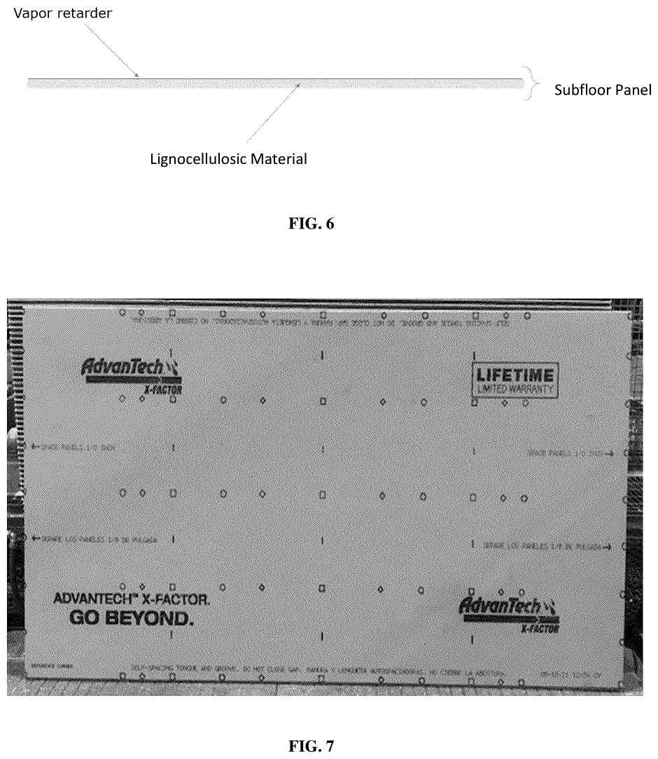

Three test specimens measuring 5.75-inch were tested with a round pan design similar to the example in ASTM E96 (2022), FIG. 1. Test specimens were sealed to the open mouth of a test dish containing desiccant with the edges of the specimen sealed around the top ledge of the pan with microcrystalline wax (60%) mixed with refined crystalline paraffin wax (40%). An additional blank dish was prepared to serve as a control.

Three test samples of the same specimen were utilized, which allowed for reporting of three individual value and an average of those three values. ASTM E96 requires testing three replicate samples. Herein, the three samples were from the same specimen.

Assemblies of test specimens sealed to test dishes were placed into a controlled atmosphere maintained at 73±4° F. (23±2° C.) and 50±5% RH. Periodic mass collections determined the rate of water vapor movement through the specimens. The reported permeance was calculated using the method outlined in ASTM E96 (2022), Section 15.2.1. The permeance was corrected using the “Edge Mask Correction” method outlined in ASTM E96 (2022), Section 15.6.2, where the mouth area defines the test. To calculate permeance, water vapor transmission was first determined and then permeance was calculated by dividing the water vapor transmission by the vapor pressure across the tested material.

The desiccant method of testing water vapor transmission was performed in accordance with ASTM E96/E96M-22 “Standard Test Methods for Gravimetric Determination of Water Vapor Transmission Rate of Materials”, Appendix X1.1.1, (Procedure A—Desiccant Method).

The specimens were conditioned for not less than 24 hours at 73.4±3.6° F. (23±2° C.), and 50±5% relative humidity before testing.

TABLE 1
Test parameters.

| Procedure Used | A - desiccant |
|---|---|
| Temperature (° F./° C.) | 73.4/23.0 |
| Relative Humidity (%) Dry Side | 0.0 |
| Relative Humidity (%) Wet Side | 50.0 |
| Relative Humidity (% ) Mean | 25.0 |
| Test Duration (h) | 505 |

TABLE 2
Results

| Specimen | 1 | 2 | 3 | Average |
|---|---|---|---|---|
| Mass Change (g) | 0.77 | 0.79 | 2.01 | 1.19 |
| Specimen Area (m²) | 0.0134 | 0.0134 | 0.0134 | 0.0134 |
| Water Vapor | 0.114 | 0.117 | 0.297 | 0.176 |
| Transmission (g/h · m²) | | | | |
| Saturation Pressure | 2808.9 | 2808.9 | 2808.9 | 2808.9 |
| (pascal) | | | | |
| Pressure Difference | 1404.5 | 1404.5 | 1404.5 | 1404.5 |
| (pascal) | | | | |
| Permeance (ng/Pa · | 22.5 | 23.1 | 59.0 | 34.9 |
| s · m²) | | | | |
| Permeance (perms) | 0.39 | 0.40 | 1.03 | 0.61 |
| Thickness (mm) | 0.25 | 0.25 | 0.25 | 0.25 |

The measured average permeance for the material was 0.61 perm (34.9 ng/Pa·s·m²) under the conditions of the test, thereby demonstrating that the subfloor panel is a Class II vapor retarder because it falls within the range of 0.1 to 1 perm.

Product 2: Cured Vapor Retarder without Screen Imprint

The test vapor retarder specimens were cured vapor retarder prior to integration with lignocellulosic material. The vapor retarder comprised paper and resin. The vapor retarder was cured by pressing the paper in a mini press using heat, time, and pressure.

Three test specimens measuring 5.75-inch were tested with a round pan design similar to the example in ASTM E96, FIG. 1, 2022. Test specimens were sealed to the open mouth of a test dish containing desiccant, with the edges of the specimen sealed around the top ledge of the pan with microcrystalline wax (60%) mixed with refined crystalline paraffin wax (40%). An additional blank dish was prepared to serve as a control.

Three test samples of the same specimen were utilized, which allowed for reporting of three individual value and an average of those three values.

Assemblies were placed into a controlled atmosphere maintained at 73±4° F. (23±2° C.) and 50±5% RH. Periodic mass collections determine the rate of water vapor movement through the specimens. The reported permeance was calculated using the method outlined in ASTM E96 (2022), Section 15.2.1. The permeance was corrected using the “Edge Mask Correction” method outlined in ASTM E96 (2022), Section 15.6.2, where the mouth area defines the test. Two product types were evaluated in accordance with ASTM E96 (2022), Procedure A.

The desiccant method of testing water vapor transmission was performed in accordance with ASTM E96/E96M-22 “Standard Test Methods for Gravimetric Determination of Water Vapor Transmission Rate of Materials”, Appendix X1.1.1, (Procedure A—Desiccant Method).

The specimens were conditioned for not less than 24 hours at 73.4±3.6° F. (23±2° C.), and 50±5% relative humidity before testing.

TABLE 3
Test parameters.

| Procedure Used | A - desiccant |
|---|---|
| Temperature (° F./° C.) | 73.4/23.0 |
| Relative Humidity (% ) Dry Side | 0.0 |
| Relative Humidity (%) Wet Side | 50.0 |
| Relative Humidity (%) Mean | 25.0 |
| Test Duration (h) | 503 |

TABLE 4
Results

| Specimen | 1 | 2 | 3 | Average |
|---|---|---|---|---|
| Mass Change (g) | 1.90 | 1.97 | 2.19 | 2.02 |
| Specimen Area (m²) | 0.0134 | 0.0134 | 0.0134 | 0.0134 |
| Water Vapor | 0.281 | 0.291 | 0.324 | 0.299 |
| Transmission (g/h · m²) | | | | |
| Saturation Pressure | 2808.9 | 2808.9 | 2808.9 | 2808.9 |
| (pascal) | | | | |
| Pressure Difference | 1404.5 | 1404.5 | 1404.5 | 1404.5 |
| (pascal) | | | | |
| Permeance (ng/Pa · | 55.9 | 58 | 64 | 59 |
| s · m²) | | | | |
| Permeance (perms) | 0.97 | 1.0 | 1.1 | 1.0 |
| Thickness (mm) | 0.25 | 0.25 | 0.25 | 0.25 |

The measured average permeance for the material was 1.0 perm (59 ng/Pa·s·m²) under the conditions of the test, thereby demonstrating that the subfloor panel is a Class II vapor retarder because it falls within the range of 0.1 to 1 perm.

### Example 2: Water Vapor Transmission of Subfloor Panels-Water Method

### Product 1: Subfloor Panel-OSB and No Seam

This example measured the water vapor transmission and permeance of a sample of subfloor panel having no seam and comprising vapor retarder and oriented strand board in order to determine whether the subfloor panel is a Class II vapor retarder.

Three test specimens measuring 5.75-inch ø were tested with a round pan design similar to the example in ASTM E96 (2022), FIG. 1. Test specimens were sealed to the open mouth of a test dish containing desiccant or water, with the edges of the specimen sealed around the top ledge of the pan with microcrystalline wax (60%) mixed with refined crystalline paraffin wax (40%). An additional blank dish was prepared to serve as a control.

Assemblies were placed into a controlled atmosphere maintained at 73±4° F. (23±2° C.) and 50±5% RH. Periodic mass collections determine the rate of water vapor movement through the specimens. The reported permeance was calculated using the method outlined in ASTM E96 (2022), Section 15.2.1. The permeance was corrected using the “Edge Mask corrector” method outlined in ASTM E96, Section 15.6.2 where the mouth area defines the test area of the specimen.

The water method of testing water vapor transmission was performed in accordance with ASTM E96/E96M-22 “Standard Test Methods for Gravimetric Determination of Water Vapor Transmission Rate of Materials”, Appendix X1.1.1, (Procedure B—Water Method).

The specimens were conditioned for not less than 24 hours at 73.4±3.6° F. (23±2° C.), and 50±5% relative humidity before testing.

TABLE 5
Test parameters.

| Procedure Used | B - water |
|---|---|
| Temperature (° F./° C.) | 73.4/23.0 |
| Relative Humidity (% ) Dry Side | 50.0 |
| Relative Humidity (%) Wet Side | 100.0 |
| Relative Humidity (% ) Mean | 75.0 |

TABLE 6
Results

| Specimen | 1 | 2 | 3 | Average |
|---|---|---|---|---|
| Mass Change (g) | 1.95 | 1.86 | 0.49 | 1.43 |
| Specimen Area (m²) | 0.0134 | 0.0134 | 0.0134 | 0.0134 |
| Water Vapor | 0.164 | 0.156 | 0.041 | 0.120 |
| Transmission (g/h · m²) | | | | |
| Saturation Pressure | 2808.9 | 2808.9 | 2808.9 | 2808.9 |
| (pascal) | | | | |
| Pressure Difference | 1404.5 | 1404.5 | 1404.5 | 1404.5 |
| (pascal) | | | | |
| Permeance (ng/Pa · | 32.5 | 31.1 | 8.1 | 23.9 |
| s · m²) | | | | |
| Permeance (perms) | 0.57 | 0.54 | 0.14 | 0.42 |
| Thickness (mm) | 18.03 | 18.03 | 18.03 | 18.03 |

The measured average permeance for the material was 0.42 perm (23.9 ng/Pa·s·m²) under the conditions of the test, thereby demonstrating that the subfloor panel is a Class II vapor retarder because it falls within the range of 0.1 to 1 perm.

### Product 2: Subfloor Panel-OSB and a No-Glue Tongue and Groove Seam

This example measured the water vapor transmission and permeance of a sample of subfloor panel having a seam and comprising vapor retarder and oriented strand board in order to determine whether the subfloor panel is a Class II vapor retarder.

Three test specimens measuring 5.75-inch ø were tested with a round pan design similar to the example in ASTM E96 (2022), FIG. 1. Test specimens were sealed to the open mouth of a test dish containing desiccant or water, with the edges of the specimen sealed around the top ledge of the pan with microcrystalline wax (60%) mixed with refined crystalline paraffin wax (40%). An additional blank dish was prepared to serve as a control.

Assemblies were placed into a controlled atmosphere maintained at 73±4° F. (23±2° C.) and 50±5% RH. Periodic mass collections determine the rate of water vapor movement through the specimens. The reported permeance was calculated using the method outlined in ASTM E96 (2022), Section 15.2.1. The permeance was corrected using the “Edge Mask corrector” method outlined in ASTM E96, Section 15.6.2 where the mouth area defines the test area of the specimen.

The water method of testing water vapor transmission was performed in accordance with ASTM E96/E96M-22 “Standard Test Methods for Gravimetric Determination of Water Vapor Transmission Rate of Materials”, Appendix X1.1.1, (Procedure B—Water Method).

The specimens were conditioned for not less than 24 hours at 73.4±3.6° F. (23±2° C.), and 50±5% relative humidity before testing.

TABLE 7
Test parameters.

| Procedure Used | B - water |
|---|---|
| Temperature (° F./° C.) | 73.4/23.0 |
| Relative Humidity (%) Dry Side | 50.0 |
| Relative Humidity (%) Wet Side | 100.0 |
| Relative Humidity (%) Mean | 75.0 |
| Test Duration (h) | 383 |

TABLE 8
Results

| Specimen | 1 | 2 | 3 | Average |
|---|---|---|---|---|
| Mass Change (g) | 1.26 | 1.25 | 1.24 | 1.25 |
| Specimen Area (m²) | 0.0134 | 0.0134 | 0.0134 | 0.0134 |
| Water Vapor | 0.218 | 0.217 | 0.216 | 0.217 |
| Transmission (g/h · m²) | | | | |
| Saturation Pressure | 2808.9 | 2808.9 | 2808.9 | 2808.9 |
| (pascal) | | | | |
| Pressure Difference | 1404.5 | 1404.5 | 1404.5 | 1404.5 |
| (pascal) | | | | |
| Permeance (ng/Pa · | 43.5 | 43.3 | 43.0 | 43.2 |
| s · m²) | | | | |
| Permeance (perms) | 0.76 | 0.75 | 0.75 | 0.75 |
| Thickness (mm) | 18.29 | 18.29 | 18.03 | 18.20 |

The measured average permeance for the material was 0.75 perm (43.2 ng/Pa·s·m²) under the conditions of the test, thereby demonstrating that the subfloor panel is a Class II vapor retarder because it falls within the range of 0.1 to 1 perm.

### Product 3: Subfloor Panel-OSB and a Glued Tongue and Groove Seam

This example measured the water vapor transmission and permeance of a sample of subfloor panel having a glued tongue and groove seam and comprising vapor retarder and oriented strand board in order to determine whether the subfloor panel is a Class II vapor retarder.

Three test specimens measuring 5.75-inch ø were tested with a round pan design similar to the example in ASTM E96 (2022), FIG. 1. Test specimens were sealed to the open mouth of a test dish containing desiccant or water, with the edges of the specimen sealed around the top ledge of the pan with microcrystalline wax (60%) mixed with refined crystalline paraffin wax (40%). An additional blank dish was prepared to serve as a control. Assemblies were placed into a controlled atmosphere maintained at 73±4° F. (23±2° C.) and 50±5% RH. Periodic mass collections determine the rate of water vapor movement through the specimens. The reported permeance was calculated using the method outlined in ASTM E96 (2022), Section 15.2.1. The permeance was corrected using the “Edge Mask corrector” method outlined in ASTM E96, Section 15.6.2 where the mouth area defines the test area of the specimen.

The water method of testing water vapor transmission was performed in accordance with ASTM E96/E96M-22 “Standard Test Methods for Gravimetric Determination of Water Vapor Transmission Rate of Materials”, Appendix X1.1.1, (Procedure B—Water Method).

The specimens were conditioned for not less than 24 hours at 73.4±3.6° F. (23±2° C.), and 50±5% relative humidity before testing.

TABLE 9
Test parameters.

| Procedure Used | B - water |
|---|---|
| Temperature (° F./° C.) | 73.4/23.0 |
| Relative Humidity (%) Dry Side | 50.0 |
| Relative Humidity (%) Wet Side | 100.0 |
| Relative Humidity (%) Mean | 75.0 |
| Test Duration (h) | 505 |

TABLE 10
Results

| Specimen | 1 | 2 | 3 | Average |
|---|---|---|---|---|
| Mass Change (g) | 1.69 | 1.28 | 1.08 | 1.35 |
| Specimen Area (m²) | 0.0134 | 0.0134 | 0.0134 | 0.0134 |
| Water Vapor | 0.222 | 0.169 | 0.142 | 0.178 |
| Transmission (g/h · m²) | | | | |
| Saturation Pressure | 2808.9 | 2808.9 | 2808.9 | 2808.9 |
| (pascal) | | | | |
| Pressure Difference | 1404.5 | 1404.5 | 1404.5 | 1404.5 |
| (pascal) | | | | |
| Permeance (ng/Pa · | 44.3 | 33.5 | 28.2 | 35.3 |
| s · m²) | | | | |
| Permeance (perms) | 0.77 | 0.58 | 0.49 | 0.62 |
| Thickness (mm) | 18.29 | 18.03 | 18.29 | 18.20 |

The measured average permeance for the material was 0.62 perm (35.3 ng/Pa·s·m²) under the conditions of the test, thereby demonstrating that the subfloor panel is a Class II vapor retarder because it falls within the range of 0.1 to 1 perm.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods and compositions of the appended claims are not limited in scope by the specific methods and compositions described herein, which are intended as illustrations of a few aspects of the claims and any methods and compositions that are functionally equivalent are intended to fall within the scope of the claims. Various modifications of the methods and compositions in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A subfloor panel comprising a lignocellulosic material suitable for use as a subfloor and an integrated vapor retarder coextensive to at least one surface of the lignocellulosic material, wherein the lignocellulosic material comprises a first resin and the vapor retarder comprises a second resin.

2. The subfloor panel of claim 1, wherein the subfloor panel has a permeance of from about 0.1 to about 1.0 perms, as measured per ASTM E96-22 water method (Method B).

3. The subfloor panel of claim 1, wherein the subfloor panel has a permeance of from about 0.1 to about 1.0 perms, as measured per ASTM E96-22 desiccant method (Method A).

4. The subfloor panel of claim 1, wherein the subfloor panel has a permeance of from about 0.1 to about 1.0 perms, as measured per ASTM E96-22 desiccant method (Method A) and/or ASTM E96-22 water method (Method B).

5. The subfloor panel of claim 1, wherein the lignocellulosic material comprises oriented strand board (OSB).

6. The subfloor panel of claim 1, wherein the first resin comprises phenyl formaldehyde (PF).

7. The subfloor panel of claim 1, wherein the first resin comprises isocyanate.

8. The subfloor panel of claim 7, wherein the isocyanate comprises polymeric methylene diphenyl diisocyanate (pMDI).

9. The subfloor panel of claim 1, wherein the vapor retarder is integrated to a top surface of the lignocellulosic material, a bottom surface of the lignocellulosic material, or both the top and bottom surfaces of the lignocellulosic material.

10. The subfloor panel of claim 9, wherein the top surface of the lignocellulosic material or the bottom surface of the lignocellulosic material is sanded.

11. The subfloor panel of claim 1, wherein the vapor retarder comprises paper.

12. The subfloor panel of claim 1, wherein the vapor retarder further comprises an ultraviolet (UV) stabilizer.

13. The subfloor panel of claim 1, wherein the first resin and second resin comprise different resins.

14. The subfloor panel of claim 1, wherein the vapor retarder comprises a screen imprint.

15. The subfloor panel of claim 11, wherein the paper has a paper basis weight of from about 50 to about 150 pounds per 100 square feet (sq. ft.).

16. The subfloor panel of claim 1, wherein the subfloor panel has a density of from about 38 to about 50 pounds per feet cubed (lbs./ft.³).

17. The subfloor panel of claim 1, wherein the subfloor panel has a modulus of elasticity of from about 0.4×10⁶ to about 1.2×10⁶ pounds per square inch (psi).

18. The subfloor panel of claim 1, wherein the subfloor panel has a wet coefficient of friction of from about 0.6 to about 1.3.

19. The subfloor panel of claim 1, wherein the subfloor panel has a dry coefficient of friction of about 0.9 or higher.

20. The subfloor panel of claim 1, wherein the subfloor panel has a thickness of from about 0.650 to about 1.175 inches.

21. The subfloor panel of claim 1, wherein the vapor retarder comprises paper and a first resin, further wherein the lignocellulosic material comprises oriented strand board which further comprises a second resin, wherein the second resin comprises pMDI, further wherein the subfloor panel has a permeance of from about 0.1 to about 1.0 perms, as measured per ASTM E96-22 water method (Method B).

22. The subfloor panel of claim 1, wherein the vapor retarder comprises paper and a first resin, further wherein the lignocellulosic material comprises oriented strand board which further comprises a second resin, wherein the second resin comprises pMDI, further wherein the subfloor panel has a permeance of from about 0.1 to about 1.0 perms, as measured per ASTM E96-22 desiccant method (Method A).

23. The subfloor panel of claim 1, wherein the vapor retarder comprises paper and a first resin, further wherein the lignocellulosic material comprises oriented strand board which further comprises a second resin, wherein the second resin comprises pMDI, further wherein the subfloor panel has a permeance of from about 0.1 to about 1.0 perms, as measured per ASTM E96-22 desiccant method (Method A) and/or ASTM E96-22 water method (Method B).

24. A floor assembly comprising one or more subfloor panels of claim 1 and a finish flooring material.

25. The floor assembly of claim 24, wherein the finish flooring material is a hardwood flooring material, engineered flooring material, natural stone tile, porcelain tile, or linoleum.

26. The floor assembly of claim 24, wherein multiple subfloor panels are present and are joined together with a tongue and groove joint.

27. The floor assembly of claim 24, wherein multiple subfloor panels are present and are sealed between the panels with a seam sealant.

28. The floor assembly of claim 23, wherein the seam sealant is a tape.

29. The floor assembly of claim 24, further comprising at least one subfloor fastener positioned to fasten the floor assembly to an underlying framing.
